(19) United States
(12) Patent Application Publication
(10) Pub. No.: US 2024/0125084 A1
(43) Pub. Date: Apr. 18, 2024

(54) SKID STEER RAKE WITH VARIABLE SCARIFIERS AND CLOD-CLEAVING WHEELS

(71) Applicant: Brian Craig, Congerville, IL (US)

(72) Inventor: Brian Craig, Congerville, IL (US)

(21) Appl. No.: 17/964,391

(22) Filed: Oct. 12, 2022

(51) Int. Cl. E02F 3/815; A01B 35/10

(52) U.S. Cl. CPC E02F 3/815; A01B 35/10

(57) ABSTRACT

The invention provides a skid steer rake capable of adjustment and modulation during use, without any need to halt operation of attached machinery. The skid steer rake is configured with a plurality of scarifiers capable of deployment and retraction during course of use of the device, as well as a landscape rake and a plurality of clod-cleaving wheels. The scarifiers can be latched in various positions depending on the user's needs. The skid steer rake can be operated in a push or pull configuration, if necessary. Another embodiment of the skid steer rake is configured to have clod-cleaving wheels adjustable to the uneven terrain while maintaining contact of the scarifiers and the skid steer rake with the ground surface.

### BACKGROUND OF THE INVENTION

The present invention relates to agriculture and landscaping. Particularly, a skid steer rake having variable scarifiers capable of adjustment during use, allowing momentary conversion of the skid rake from one configuration to another, without complete removal or modification of skid rake implement itself, as well as integrated clod-cleaving wheels capable of soil smoothing and clodding, as well as forming a variable depth guide for the skid steer rake.

Rake implements and attachments are utilized in various landscaping and agricultural techniques, including preparation of soil for seeding, land clearing and grubbing, land grading and leveling, terrain restoration, as well as land finishing processes. These processes can include the compaction, decompaction, scarification, crumbling, sizing/pulverization, grading and leveling, grubbing, and debris clearing of the soil and/or general landscape. Typical rakes are designed to carry out one or two of these processes, with multiple implements being required to accomplish the overall technique or result. These specifically designed rakes include grading blades, wire tines, power box rakes, land planes, land levelers, and rock rakes; each having functional limitations that must be supplemented by another.

For example, many currently available rake attachments with scarifiers operate with the scarifiers in a fixed position, meaning that a user cannot adjust the depth of the scarifying process or that the user must manually adjust each of the scarifiers in order to achieve the desired resulting depth. This both increases the time required for a user to carry out a given process on soil, as well as requires additional attachments or other implements entirely in order to carry out any subsequent processes in order to finish the soil or get it ready for seeding. Implements with fixed scarifiers also typically require manual removal or retraction of the scarifiers either while the rake is not in use or when it is being used to carry out a process that does not involve scarification. Beyond sub-optimal scarifier depth consistency and adjustment, typical rake attachments can also lack the capability of consistent rake depth across a given area of land or soil.

Additionally, many current rake implements and attachments require on-board hydraulics systems in order to operate in-part or at all. Such hydraulic devices typically require additional maintenance in order to continue functioning properly, as well the additional energy consumption of said hydraulics.

The present invention attempts to remedy the shortcomings of prior art skid steer rakes by providing a skid steer rake having variable scarifiers that can be deployed and retracted while the skid steer rake is in operation. The present invention also attempts to remedy shortcomings of prior art skid steer rakes by further providing integrated clod-cleaving wheels that enable further methods of soil workability, as well as forming a depth guide for the skid steer rake. Finally, the present invention attempts to ensure that the skid steer rake and the scarifiers remain in contact with the ground surface when the clod-cleaving wheels travel through an uneven terrain.

### BRIEF DESCRIPTION OF THE INVENTION

The present invention provides a skid steer rake capable of adjustment and modulation during use, without any need to halt operation of attached machinery. In one embodiment of the invention, the skid steer rake is configured with a plurality of variable scarifiers capable of deployment and retraction during course of use of the device.

The skid steer rake has a main body comprising a rake plate, an attachment plate, and at least two lateral plates. The rake plate is positioned opposite from the attachment plate, with both the rake plate and the attachment plate each coupled to at least two of the at least two lateral plates. The rake plate may comprise a protruding lip that is configured to allow attachment of a landscape rake thereto. Each of the rake plate, attachment plate, and at least two lateral plates further comprises an interior face and an exterior face.

The attachment plate is configured to allow coupling and decoupling of a power unit, such as a skid steer, to the exterior face thereof. The interior face of the attachment plate comprises at least one scarifier latch and a plurality of scarifiers. The scarifier latch comprises a bracket and lever, the bracket coupled to the attachment plate and configured to movably couple the lever. The lever of the scarifier latch comprises a plurality of ridges disposed along a surface thereof, each configured to couple and retain the plurality of scarifiers by rotating about an axis formed by the bracket of the scarifier latch. The plurality of ridges also allows retention of the at least one scarifier in various different positions, forming different angles between the at least one scarifier and a ground surface. The plurality of scarifiers is configured to engage a ground surface and carry out scarifying processes, by cutting, clodding, or otherwise manipulating the ground surface and soil and removing large masses therefrom.

In some embodiments of the invention, the interior face of the attachment plate also comprises a plurality of scarifier mounts, each mount configured to movably couple at least one scarifier. In other embodiments, the plurality of scarifier mounts is configured to movably couple a scarifier axle, the axle configured to couple and retain the plurality of scarifiers thereto.

In other embodiments of the invention, the plurality of scarifier mounts is coupled to and disposed through the at least two lateral plates of the invention, and the scarifier axle is held by the plurality of scarifier mounts such that the scarifier axle is also disposed through the at least two lateral plates.

The skid steer rake further comprises a plurality of clod-cleaving wheels configured to engage a ground surface and both manipulate soil, as well as form a depth stop for both the plurality of scarifiers and the landscape rake of the invention. The plurality of clod-cleaving wheels is coupled to a clod-cleaver axle which is configured to allow rotation of the plurality of clod-cleaving wheels about an axis formed by the axle. The clod-cleaver axle is further coupled by and disposed through the at least two lateral plates. The plurality of clod-cleaving wheels operates as a depth stop by acting as a fulcrum point for the invention while engaging with the ground surface, preventing either the landscape rake or the plurality of scarifiers from gouging said ground surface.

The invention can be operated in a push configuration or in a pull configuration, with the plurality of scarifiers in a latched state or in an unlatched state. In an unlatched state, the plurality of scarifiers are capable of rotating about an axis formed by either the scarifer axle or a scarifier mount. While unlatched, the plurality of scarifiers may freely rotate until the plurality of scarifiers either enter the latched state or engage with the ground surface.

While being pushed, the landscape rake of the invention engages the ground surface and performs grading functions, while the plurality of clod-cleaving wheels form a depth stop to prevent gouging from occurring. While being pulled by a power unit, the plurality of clod-cleaving wheels is also configured to crumble clods that are broken out from the ground surface by the plurality of scarifiers. The plurality of scarifiers is also configured such that the depth of ground penetration can be modulated by a user adjusting an angle formed between the skid steer rake to the attached power unit. The plurality of clod-cleaving wheels again forms a depth stop to prevent excessive ground penetration and gouging by the plurality of scarifiers.

During operation of the invention, the plurality of scarifiers may be latched and unlatched without halting said operation of the invention. While in the push configuration, a user, while operating the power unit, will roll the skid steer rake within close proximity to the attached power unit. In doing so, the at least one scarifier latch will rotate into a latching position and the plurality of scarifiers will rotate about the scarifier axle. The scarifier latch will then engage the plurality of scarifiers, thereby coupling and holding the plurality of scarifiers in a latched position. The scarifier latch may be configured to engage the plurality of scarifiers at various positions to allow a variety of angles at which the plurality of scarifiers may engage the ground surface. The aforementioned method for latching can be implemented in order to change between said various positions.

The plurality of scarifiers can be unlatched during operation of the invention by a user rotating, through use of the power unit, the skid steer rake into a vertical position, such that a main axis of the invention is perpendicular to the ground surface. The user then quickly moves the invention back and forth, thereby generating torque sufficient to rotate the plurality of scarifiers along the scarifier axle. The plurality of scarifiers is rotated past a given latched position, causing the at least one scarifier latch to disengage from the scarifiers. Once the skid steer rake is returned to a horizontal position, the plurality of scarifiers will be rotationally free of the scarifier latch and will not engage, thereby rotating into an unlatched position.

Another embodiment of the present invention features a cultipacker subframe carrying clod-cleaving wheels and pivotally coupled to the at least two lateral plates through adjustable limits. The adjustable limits have a plurality of hinge points and removable latches, which allows the clod-cleaving wheels to pivot, adjusting the clod-cleaving wheels to the uneven terrain, while maintaining the scarifiers and the landscape rake in contact with the ground surface.

The methods, systems, and apparatuses are set forth in part in the description which follows, and in part will be obvious from the description, or can be learned by practice of the methods, apparatuses, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed. More details concerning these embodiments, and others, are further described in the following figures and detailed description set forth herein below.

### BRIEF DESCRIPTION OF THE DRAWINGS

FIG. 1 illustrates a profile view of the skid steer rake in a push configuration.

FIG. 2 illustrates a profile view of the skid steer rake in a pull configuration.

FIG. 3 illustrates a profile view of the skid steer rake where the scarifiers are deeply engaging a ground surface.

FIG. 4 illustrates a profile view of the skid steer rake in a push configuration with the plurality of scarifiers and scarifier latch rotating positions.

FIG. 5 illustrates a profile view of the skid steer rake in a latch switching position as lifted by a power unit (not depicted) by an attachment plate.

FIG. 6 illustrates a profile view of the skid steer rake in another latch switching position as lifted by a power unit (not depicted) by an attachment plate.

FIG. 7 illustrates a profile view of the skid steer rake embodiment with an adjustable cultipacker subframe in a push configuration.

FIG. 8 illustrates a profile view of the skid steer rake embodiment with an adjustable cultipacker subframe in a pull configuration.

FIG. 9 illustrates a profile view of the skid steer rake embodiment with an adjustable cultipacker subframe where the scarifiers are deeply engaging a ground surface.

FIG. 10 illustrates a profile view of the skid steer rake embodiment with an adjustable cultipacker subframe in a push configuration with the plurality of scarifiers and scarifier latch rotating positions.

FIG. 11 illustrates a profile view of the skid steer rake embodiment with an adjustable cultipacker subframe in a latch switching position as lifted by a power unit (not depicted) by an attachment plate.

FIG. 12 illustrates a profile view of the skid steer rake embodiment with an adjustable cultipacker subframe in another latch switching position as lifted by a power unit (not depicted) by an attachment plate.

FIG. 13 illustrates a profile view of the skid steer rake embodiment with an adjustable cultipacker subframe with latches on both limits engaged with the at least two lateral plates.

FIG. 14 illustrates a perspective view of the skid steer rake embodiment with an adjustable cultipacker subframe.

### DETAILED DESCRIPTION OF THE INVENTION

The present invention provides a skid steer rake capable of adjustment and modulation during use, without any need to halt operation of attached machinery. In one embodiment of the invention, the skid steer rake is configured with a plurality of variable scarifiers capable of deployment and retraction during course of use of the device.

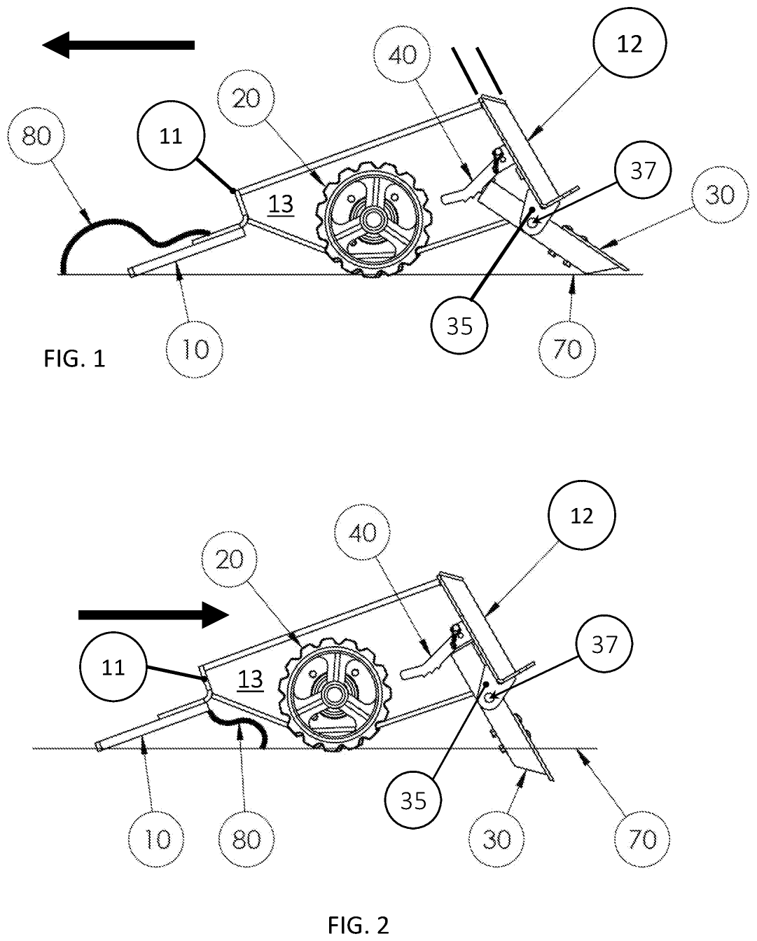

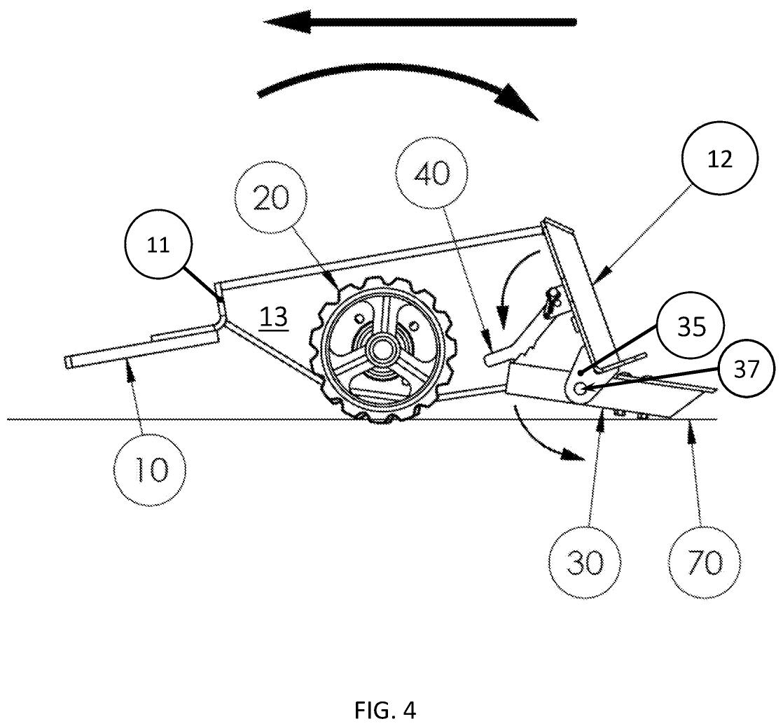

The skid steer rake, as shown in FIGS. 1-6, has a main body comprising a rake plate 11, an attachment plate 12, and at least two lateral plates 13. The rake plate 11 is positioned opposite from the attachment plate 12, with both the rake plate 11 and the attachment plate 12 each coupled to at least two of the at least two lateral plates 13. The rake plate 11 further comprises a protruding lip that is configured to allow attachment of a landscape rake 10 thereto. Each of the rake plate 11, attachment plate 12, and at least two lateral plates 13 further comprises an interior face and an exterior face.

The attachment plate 12 is configured to allow coupling and decoupling of a power unit, such as a skid steer, to the exterior face thereof. The power unit provides a requisite force in order to operate the skid steer rake and any implement that can provide said sufficient force. The power unit may comprise a skid steer, track loader, tractor, or other implement capable of coupling to and operating or otherwise manipulating the invention. The landscape rake 10 comprises a comb-like structure configured to engage with a top surface of a ground surface 80. In some embodiments the landscape rake 10 may also comprise a blade or edge member configured to allow cutting processes to be carried out.

The interior face of the attachment plate comprises at least one scarifier latch 40. The scarifier latch 40 comprises a bracket and lever, the bracket coupled to the attachment plate and configured to movably couple the lever. The lever of the scarifier latch 40 comprises a plurality of ridges disposed along a surface thereof, each configured to couple and retain at least one scarifier 30 by rotating about an axis formed by the bracket of the scarifier latch 40. The plurality of ridges also allows retention of the at least one scarifier 30 in various different positions, forming different angles between the at least one scarifier and a ground surface 70.

The interior face of the attachment plate also comprises a plurality of scarifier mounts 35, each mount configured to movably couple at least one scarifier 30. Each of the plurality of scarifier mounts comprises a bracket coupled to and forming at least one scarifier axle, the axle being rotationally coupled to the at least one scarifier, allowing for movement of the at least one scarifier about said axle. In another embodiment of the invention, the plurality of scarifier mounts 35 is configured to movably couple the at least one scarifier axle 37, the axle comprising one axle member having a plurality of scarifiers 30 attached thereto.

Each of the plurality of scarifier mounts 35 is further coupled to the interior face of the attachment plate, and the at least one scarifier axle 37 is held by the plurality of scarifier mounts 35 such that the at least one scarifier axle 37 is also disposed through the at least two lateral plates. In this embodiment, the at least one scarifier axle 37 moves as a single member, such that the plurality of scarifiers 30 rotate in unison about an axis formed by the scarifier axle 37, with each of the plurality of scarifiers 30 forming an identical angle with the ground surface 70.

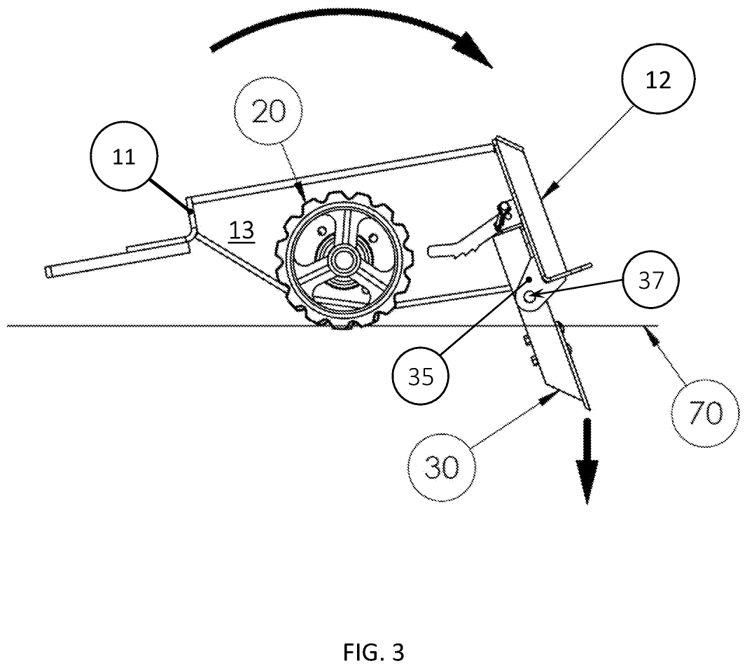

The skid steer rake further comprises a plurality of clod-cleaving wheels 20 configured to engage a ground surface 70 and manipulate soil. The plurality of clod-cleaving wheels 20 is also configured to form a depth stop for both the plurality of scarifiers 30 and the landscape rake 10 of the invention. The plurality of clod-cleaving wheels 20 is coupled to a clod-cleaver axle which is configured to allow rotation of the plurality of clod-cleaving wheels 20 about an axis formed by the axle. The clod-cleaver axle is further coupled by and disposed through the at least two lateral plates. The plurality of clod-cleaving wheels 20 operates as a depth stop by acting as a fulcrum point for the skid steer rake while engaging with the ground surface 70, preventing either the landscape rake 10 or the plurality of scarifiers 30 from gouging said ground surface 70 (as shown in FIG. 3). The depth stop capabilities of the plurality of clod-cleaving wheels 20 is dependent on what degree the skid steer rake is tilted about the fulcrum point formed by the clod-cleaver axle while the invention is engaged with the ground surface 70.

The invention can be operated in a push configuration or in a pull configuration, with the plurality of scarifiers 30 in a latched state or in an unlatched state. In an unlatched state, the plurality of scarifiers 30 are capable of rotating about an axis formed by the scarifer axle, either formed by each of the plurality of scarifier mounts 35, or a scarifier axle shared between all of the plurality of scarifiers 30. While unlatched, the plurality of scarifiers 30 may freely rotate until the plurality of scarifiers 30 either enter the latched state or engage with the ground surface 70.

While being pushed, as shown in FIG. 1, the landscape rake 10 of the invention engages the ground surface 70 and performs grading of the soil or engaged ground surface 70. Meanwhile, the plurality of clod-cleaving wheels 20 form a depth stop to prevent gouging of the ground surface 70 by the landscape rake 10 from occurring. In the push configuration, the plurality of scarifiers 30 engages the ground surface 70 after both the landscape rake 10 and the plurality of clod-cleaving wheels 20 have manipulated the ground surface 70. As such, the plurality of scarifiers 30 may either be latched in a position such that they do not engage with the ground surface 70, or the plurality of scarifiers 30 may be configured in a position such that they glide over the ground surface 70. When gliding over the ground surface 70, the plurality of scarifiers 30 may lightly engage with the ground surface 70, such that large masses of soil or ground deposits that were not sufficiently broken up by the landscape rake 10 and the plurality of clod-cleaving wheels 20 may be further broken up or manipulated by the scarifiers.

While being pulled by a power unit, shown in FIG. 2, the plurality of scarifiers 30 engages the ground surface 70 first, followed by the plurality of clod-cleaving wheels 20 and then the landscape rake 10. As such, the plurality of scarifiers 30 is configured to penetrate the ground surface and break out clods and other large masses from the ground, bringing them to the surface. The plurality of clod-cleaving wheels 20 is then configured to crumble clods and other large masses that are broken out from the ground surface by the plurality of scarifiers 30.

As shown in FIG. 3, the plurality of scarifiers 30 is also configured such that the depth of ground penetration can be modulated by a user adjusting an angle formed between the skid steer rake and the attached power unit, thereby adjusting the height at which the attachment plate is positioned above the ground.

Lowering the attachment plate closer to the ground surface 70 allows the plurality of scarifiers 30 to penetrate deeper into the ground surface 70, thereby breaking out clods or large masses from deeper in the ground. Raising the attachment plate higher and away from the ground surface 70 causes a shallower penetration of the ground surface 70 by the plurality of scarifiers 30. The plurality of clod-cleaving wheels 20 again forms a depth stop to prevent excessive ground penetration and gouging by the plurality of scarifiers 30. Additionally, lowering the attachment plate closer to the ground surface can cause the landscape rake 10 of the invention to engage less with the ground surface 70, or, if the attachment plate is sufficiently lowered, cause the landscape rake 10 to completely disengage with the ground surface 70, leaving only the plurality of scarifiers 30 and plurality of clod-cleaving wheels 20 engaging the ground surface 70.

During operation of the invention, the plurality of scarifiers 30 may be latched and unlatched without halting said operation of the invention. While in the push configuration, a user, while operating the power unit, will roll the skid steer rake within close proximity to the attached power unit. In doing so, the ground surface 70 will exert a force on the plurality of scarifiers 30, which will rotate about the scarifier axle 37. The plurality of scarifiers 30 will then in turn exert a force on the at least one scarifier latch 40 which will rotate into a latching position. The scarifier latch 40 will then engage the plurality of scarifiers via the plurality of ridges disposed upon the scarifier latch 40, thereby coupling and holding the plurality of scarifiers in a latched position. The plurality of ridges of the scarifier latch 40 is configured to engage the plurality of scarifiers 30 at various positions to allow varied a variety of angles at which the plurality of scarifiers 30 may engage the ground surface during operation. The aforementioned method for latching can be implemented in order to change between said various positions, depending on a given ridge with which the plurality of scarifiers 30 is engaged with on the scarifier latch 40.

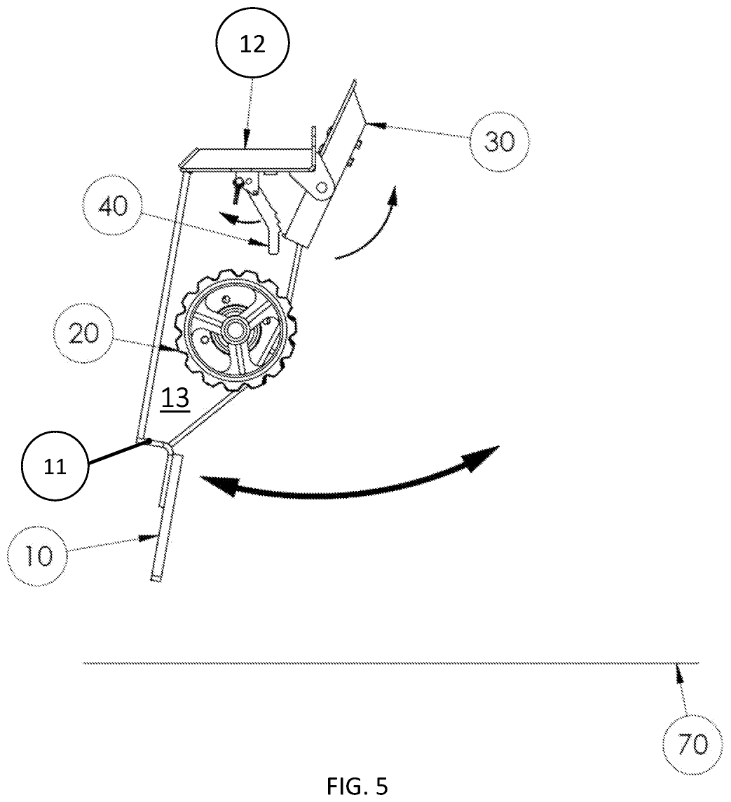

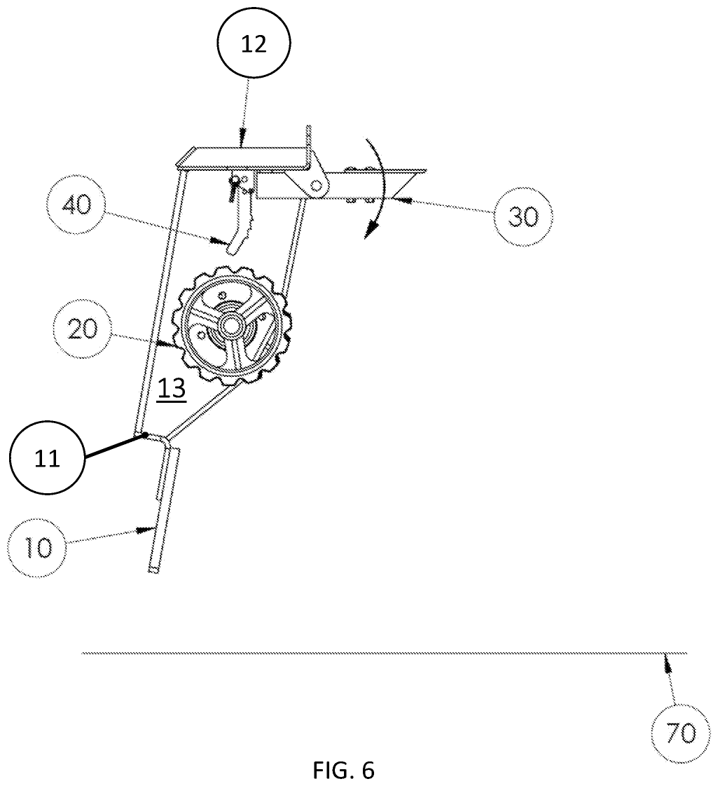

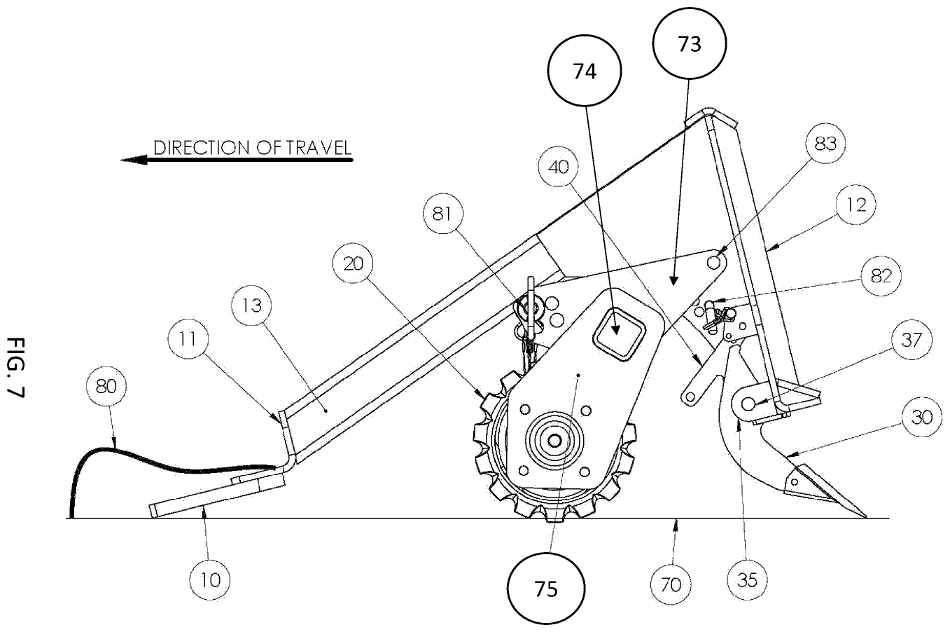

As shown in FIGS. 5-6, the plurality of scarifiers 30 can be unlatched during operation of the invention by a user rotating, through use of the power unit, the skid steer rake into a vertical position, such that a main axis of the invention is perpendicular to the ground surface 70. The user then quickly moves the invention back and forth (shown in FIG. 5), either towards a horizontal position or towards the power unit itself, thereby generating torque sufficient to rotate the plurality of scarifiers 30 along the scarifier axle 37. The plurality of scarifiers 30 is rotated past a given latched position, causing the at least one scarifier latch 40 to disengage from the scarifiers 30. Once the skid steer rake is returned to a resting position, the plurality of scarifiers 30 will be rotationally free of the scarifier latch 40 and will not engage with it, thereby rotating into an unlatched position (shown in FIG. 6).

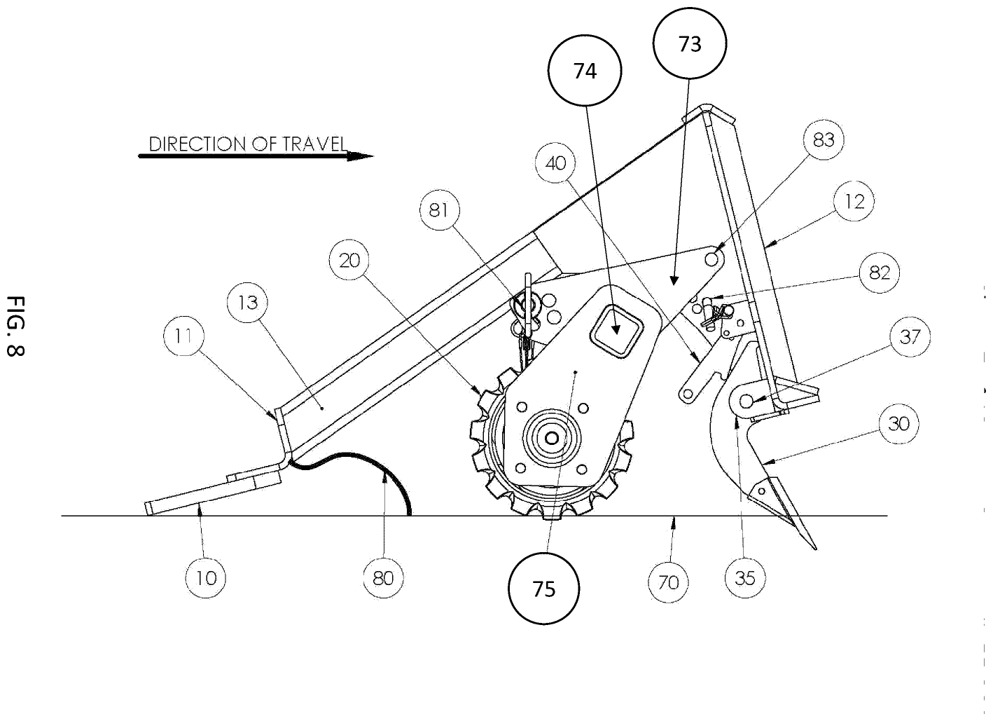

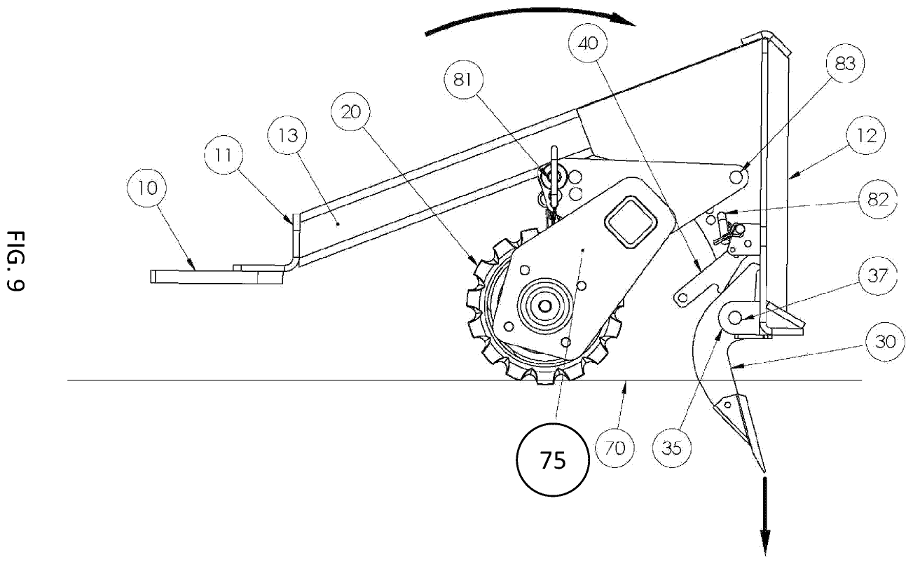

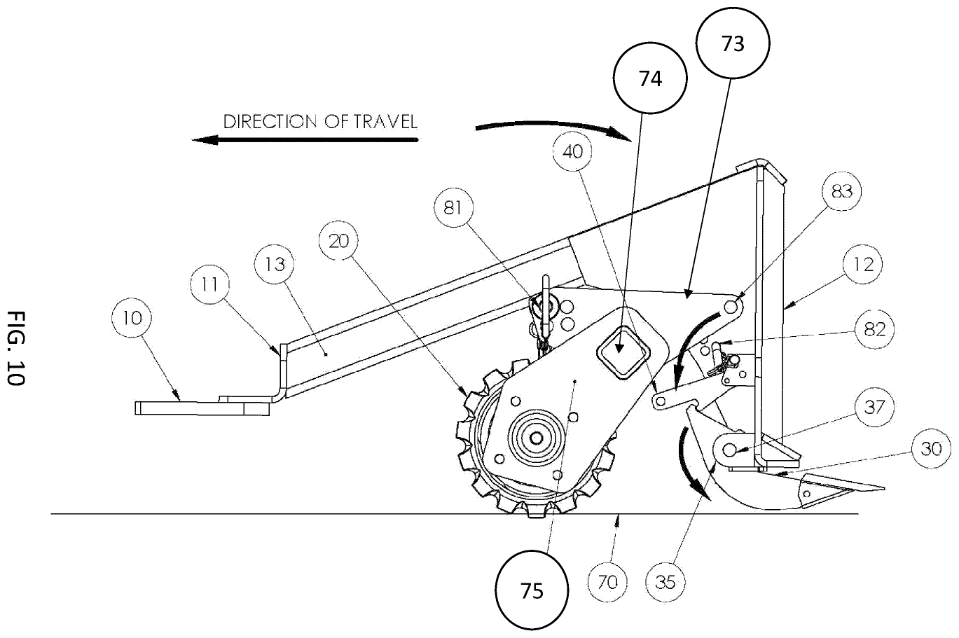

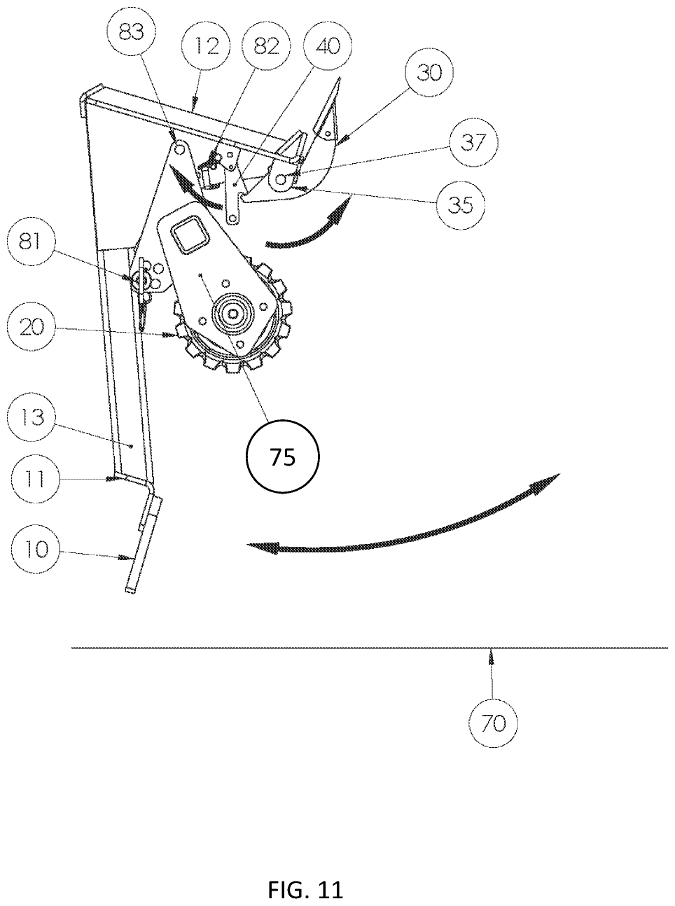

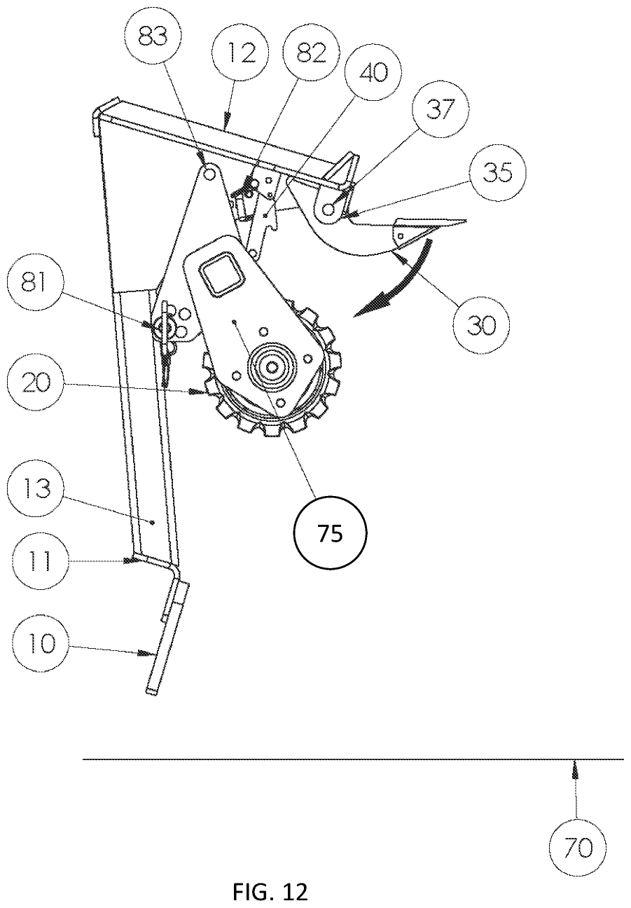

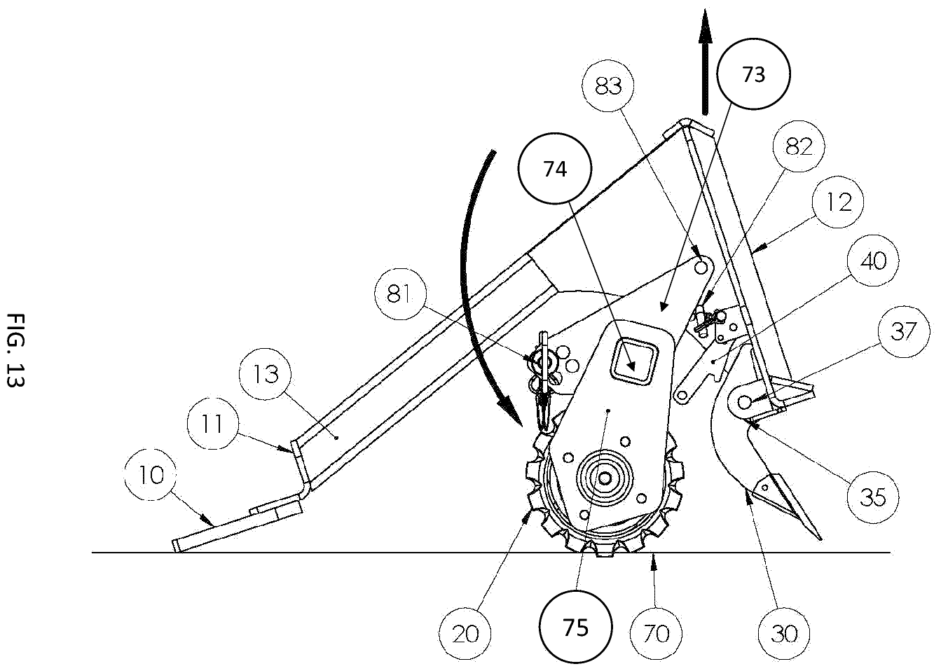

As shown on FIGS. 7-13, an embodiment of the present invention has an additional feature that helps the clod-cleaver axle adjust its pitch in relation to an uneven terrain when pulled/pushed by a power unit and simultaneously maintaining the landscape rake 10 and the plurality of scarifiers 30 in contact with the ground surface 70. The embodiment features a cultipacker subframe 75 pivotally coupled with the clod-cleaver axle and further connected via a horizontal axle 74 to a bracket 73 disposed parallel to the at least two lateral plates 13 and pivotally coupled thereto through adjustable limits 81 and 83. The adjustable limits 81 and 83 have a plurality of hinge points and removable latches.

The cultipacker subframe 75 is thus capable of adjusting its pitch to the uneven terrain as the invention is pulled/pushed. The adjustment is accomplished by the cultipacker subframe's 75 rotation along the axes formed by the adjustable limits 81 and 83 (if the latches of the limit 81 are disengaged from the at least two lateral plates 13).

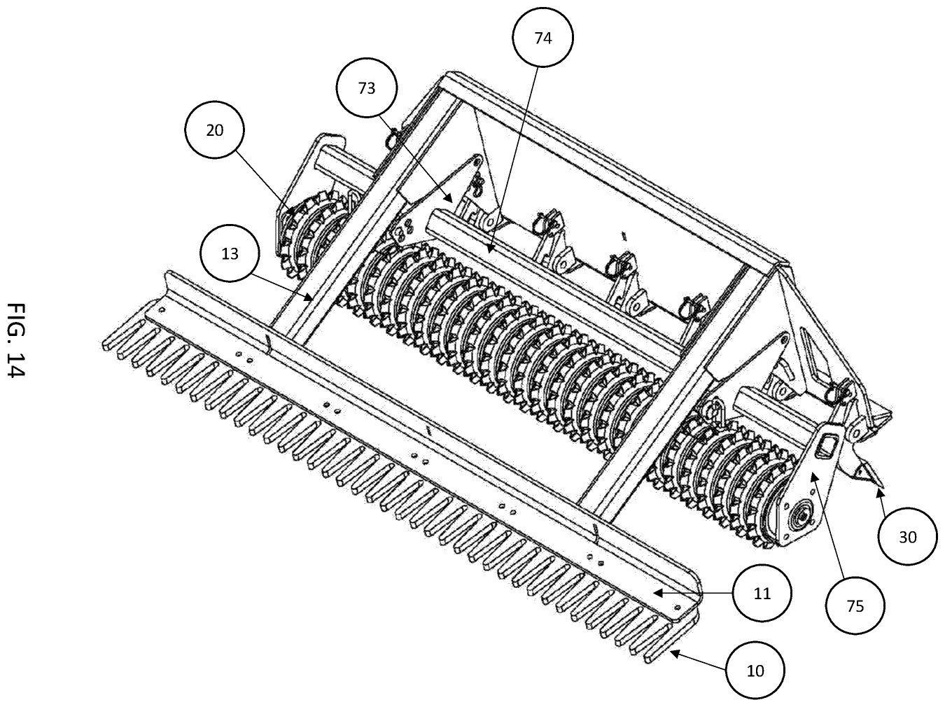

If the goals the user of the invention wants to accomplish do not require being able to constantly adjust to the changing terrain, the user may engage the latches of both limits 81 and 82 with the at least two lateral plates 13 (FIG. 13). This way, cultipacker subframe 75 will remain almost totally motionless in relation to the parts of the invention it is coupled with.

An embodiment of the present invention features a plurality of holes 82 on the bracket 73 at the adjustment end 81 for coupling with the at least two lateral plates 13 via latches, the positions of said holes accommodating for the different angles and pitches at which the bracket 73 can be disposed in relation to the ground surface 70.

While particular elements, embodiments, and applications of the present invention have been shown and described, the invention is not limited thereto because modifications may be made by those skilled in the art, particularly in light of the foregoing teaching. It is therefore contemplated by the application to cover such modifications and incorporate those features which come within the spirit and scope of the invention.

What is claimed is:

1. A skid steer rake comprising:
a. a main body having a rake plate, an attachment plate, and at least two lateral plates;
b. a landscape rake coupled to the rake plate and configured to engage a ground surface;
c. a plurality of scarifier mounts coupled to the attachment plate;
d. at least one scarifier axle rotationally coupled to and retained by the plurality of scarifier mounts;
e. a plurality of scarifiers coupled to the at least one scarifier axle;
f. at least one scarifier latch coupled to the attachment plate, the at least one scarifier latch comprising a bracket and a lever;
g. the lever of the at least one scarifier latch comprising a plurality of ridges configured to engage and retain at least one scarifier of the plurality of scarifiers; and
h. a clod-cleaver axle rotatably coupled to the at least two lateral plates, the clod-cleaver axle further comprising a plurality of clod-cleaving wheels coupled thereto.

2. The skid steer rake of claim 1, having a push configuration wherein the landscape rake engages with a ground surface first, followed by the plurality of clod-cleaving wheels, followed by the plurality of scarifiers.

3. The skid steer rake of claim 2, further having a pull configuration wherein the plurality of scarifiers engages the ground surface first, followed by the plurality of clod-cleaving wheels, followed by the landscape rake.

4. The skid steer rake of claim 3, wherein the plurality of scarifiers has a latched state and an unlatched state.

5. The skid steer rake of claim 4, wherein the plurality of scarifiers is configured to couple the least one scarifier latch at various positions, allowing the plurality of scarifiers to be configured in various latched states and unlatched states during operation.

6. The skid steer rake of claim 5, wherein the plurality of scarifiers is configured to allow adjustment between the various latched and unlatched states during operation.

7. The skid steer rake of claim 6, wherein the at least one scarifier latch engages the plurality of scarifiers while the plurality of scarifiers is in a latched state.

8. The skid steer rake of claim 7, wherein the plurality of clod-cleaving wheels forms a depth stop configured to prevent excessive gouging or penetration of the ground surface by either the landscape rake or the plurality of scarifiers.

9. The skid steer rake of claim 8, wherein the plurality of clod-cleaving wheels is further configured to crumble clods and large masses broken out from the ground surface by the plurality of scarifiers.

10. The skid steer rake of claim 9, wherein the landscape rake further comprises a blade edge configured for carrying out cutting processes on the ground surface.

11. A method for using a skid steer rake with adjustable scarifiers, comprising the following steps:
a. positioning the skid steer rake in a push configuration;
b. rolling the skid steer rake within close proximity to an attached power unit;
c. rotating a scarifier axle and plurality of scarifiers such that at least one scarifier latch is rotated into a latching position;
d. engaging the at least one scarifier latch with the plurality of scarifiers via a plurality of ridges disposed upon the at least one scarifier latch thereby configuring the plurality of scarifiers into a latched position.

12. The method of claim 11, comprising the following steps to unlatching the adjustable scarifiers:
a. lifting and rotating the skid steer rake such that it is vertical;
b. moving the skid steer rake quickly back and forth to rotate the plurality of scarifiers along the scarifier axle;
c. rotating the plurality of scarifiers past a given latched position, causing the at least one scarifier latch to disengage from the plurality of scarifiers;
d. returning the skid steer rake to a resting position, such that the plurality of scarifiers is rotationally free of and unable to engage with the at least one scarifier latch, configuring the plurality of scarifiers in an unlatched position.

13. The method of claim 12, comprising performing the steps in order to move the plurality of scarifiers from one latched position to another latched position.

14. A skid steer rake comprising:
a. a main body having a rake plate, an attachment plate, and at least two lateral plates;
b. a landscape rake coupled to the rake plate and configured to engage a ground surface;
c. a plurality of scarifier mounts coupled to the attachment plate;
d. at least one scarifier axle rotationally coupled to and retained by the plurality of scarifier mounts;
e. a plurality of scarifiers coupled to the at least one scarifier axle;
f. at least one scarifier latch coupled to the attachment plate, the at least one scarifier latch comprising a bracket and a lever;
g. the lever of the at least one scarifier latch comprising a plurality of ridges configured to engage and retain at least one scarifier of the plurality of scarifiers;
h. a clod-cleaver axle rotatably coupled to the at least two lateral plates, the clod-cleaver axle further comprising a plurality of clod-cleaving wheels coupled thereto;
i. a cultipacker subframe pivotally coupled with the clod-cleaver axle and connected to at least two brackets;
j. the at least two brackets pivotally coupled to the at least two lateral plates through two adjustable limits on each bracket;
k. the adjustable limits having a plurality of hinge points and removable latches allowing the at least two brackets to be secured against the at least two lateral plates at different angles relative to a ground surface.

15. The skid steer rake of claim 14, having a push configuration wherein the landscape rake engages with a ground surface first, followed by the plurality of clod-cleaving wheels, followed by the plurality of scarifiers.

16. The skid steer rake of claim 15, further having a pull configuration wherein the plurality of scarifiers engages the ground surface first, followed by the plurality of clod-cleaving wheels, followed by the landscape rake.

17. The skid steer rake of claim 16, wherein the plurality of scarifiers has a latched state and an unlatched state.

18. The skid steer rake of claim 17, wherein the plurality of scarifiers is configured to couple the least one scarifier latch at various positions, allowing the plurality of scarifiers to be configured in various latched states and unlatched states during operation.

19. The skid steer rake of claim 18, wherein the plurality of scarifiers is configured to allow adjustment between the various latched and unlatched states during operation.

20. The skid steer rake of claim 19, wherein the at least one scarifier latch engages the plurality of scarifiers while the plurality of scarifiers is in a latched state.

21. The skid steer rake of claim 20, wherein the plurality of clod-cleaving wheels forms a depth stop configured to prevent excessive gouging or penetration of the ground surface by either the landscape rake or the plurality of scarifiers.

22. The skid steer rake of claim 21, wherein the plurality of clod-cleaving wheels is further configured to crumble clods and large masses broken out from the ground surface by the plurality of scarifiers.

23. The skid steer rake of claim 22, wherein the landscape rake further comprises a blade edge configured for carrying out cutting processes on the ground surface.

24. A method for using a skid steer rake with adjustable clod-cleaving wheels, comprising the following steps:
a. rolling the skid steer rake within close proximity to an attached power unit;
b. unlatching the at least one adjustable limit of a cultipacker subframe pivotally coupled with a clod-cleaver axle, allowing a cultipacker subframe to pivot about axes created by the at least one adjustable limit, changing the pitch of the clod-cleaver axle in relation to the rest of the skid steer rake.
